(19) United States
(12) Patent Application Publication
(10) Pub. No.: US 2009/0160280 A1
(43) Pub. Date: Jun. 25, 2009

(54) Electric Motor

(76) Inventors: Ansgar Ackva, Würzburg (DE); Jacek Junak, Veitshöchheim (DE); Grzegorz Ombach, Veitshochheim (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/162,962

(22) PCT Filed: Jan. 16, 2007
(86) PCT No.: PCT/EP2007/050410

§ 371 Date: Nov. 7, 2008

(30) Foreign Application Priority Data
Feb. 1, 2006 (DE) 10 2006 004 608.0

(51) Int. Cl. H02K 1/17

(52) U.S. Cl. 310/154.46

(57) ABSTRACT

An electric motor with a small diameter can be provided with a stator with a comparatively small radial thickness which has the material volume required to conduct the magnetic flux. To this end, an electric motor (1) with a stator (3), has a laminated core (8) and a number of permanent magnets (6) and a rotor (2), which co-operates with the stator (3) and can rotate about a rotational axis (5). The stator (3) has a number of flux propagation elements (31), which together with the laminated core (8) are designed to conduct the magnetic flux and whose axial length (32) is greater than the axial length (4) of the laminated core (8).

### CROSS-REFERENCE TO RELATED APPLICATIONS

This application is a U.S. national stage application of International Application PCT/EP2007/050410 filed Jan. 16, 2007, which designates the United States of America, and claims priority to German application number 10 2006 004 608.0 filed Feb. 1, 2006, the contents of which are hereby incorporated by reference in their entirety.

### TECHNICAL FIELD

The invention relates to an electric motor with a stator which comprises a laminated core and with a rotor which interoperates with the stator and is able to be rotated around an axis of rotation. In particular the invention relates to a direct current motor with bushes.

### BACKGROUND

Stators with a laminated core are frequently held in a stator housing made of plastic which does not contribute to conveying the magnetic flux. By comparison with stators with a steel housing, a comparatively large stator thickness is thus needed to achieve the material volume required to convey the magnetic flux. The laminated core must therefore have a specific core thickness in the radial direction. This generally leads to large motor diameters.

This problem also arises with stators for which rare earth magnets are used as embedded permanent magnets. Rare earth magnets are characterized by a high energy product which allows a shorter motor design overall. In particular motors with a shortened axial length therefore need stators with additionally increased stator thickness in order to provide the material volume necessary for conveying the magnetic flux. As a result this leads to very large motor diameters.

### SUMMARY

An electric motor can be provided with a smaller diameter in which the stator still has the material volume necessary for conveying the magnetic flux.

According to an embodiment, in an electric motor with a stator which comprises a laminated core and a number of permanent magnets, and with a rotor interoperating with the stator and operable to be rotated around an axis of rotation, the stator may comprise a number of flux propagation elements which serve jointly with the laminated core to convey the magnetic flux, and the axial length of which is greater than the axial length of the laminated core.

According to a further embodiment, the electric motor may be a direct-current motor with brushes. According to a further embodiment, the flux propagation elements may be embodied independently of the laminated core. According to a further embodiment, the laminated core may feature a number of attachment contours for accommodating the flux propagation elements. According to a further embodiment, the attachment contours may be arranged around the outside of the laminated core. According to a further embodiment, the flux propagation elements may have a plate shape. According to a further embodiment, the flux propagation elements may at least project beyond the laminated core on the side on which the commutator is arranged. According to a further embodiment, the flux propagation elements may project beyond the laminated core on both sides. According to a further embodiment, the rotor and the laminated core may have essentially the same axial length.

### BRIEF DESCRIPTION OF THE DRAWINGS

The invention will be described below with reference to exemplary embodiments which are explained in greater detail with the aid of drawings. The drawings show the following simplified schematic diagrams:

FIG. 1 a direct-current motor with stator and rotor in a perspective view according to an embodiment,

FIG. 2 the direct current motor from FIG. 1 in a further perspective view,

FIG. 3 the laminated core of the stator of the direct current motor from FIG. 1,

FIG. 4 the flux propagation elements of the direct current motor from FIG. 1 and

FIG. 5 a diagram of the stator with a calculated density distribution of the magnetic flux.

### DETAILED DESCRIPTION

According to various embodiments, there may be provision for the stator to have a number of flux propagation elements which jointly serve with a laminated core to convey the magnetic flux and the axial length of which is greater than the axial length of the laminated core.

It can thus be made possible for the magnetic flux to be propagated in the axial direction of the motor. For this purpose flux propagation elements are provided, which in the axial direction project beyond the laminated core and thereby make it possible to convey the magnetic flux in the axial direction. As a result this leads to an increased propagation of the magnetic flux in the axial direction of the motor. This enables the stator to be built comparatively narrow in a radial direction. Despite the reduced stator thickness, a sufficient volume of material for conveying the magnetic flux is thus provided by this design.

Overall a smaller motor diameter is achieved in this way which can be compared to the diameter of a corresponding motor with a steel housing. The size of the motor can thus be reduced according to various embodiments for the same output or the output can be increased with the same motor size.

The flux propagation elements themselves can in this case be embodied in a simple manner so that the motor is simple to assemble and thereby able to be manufactured at low cost. The various embodiments are thus especially suitable for low-cost solutions.

Quite especially advantageous is the use of motors according to various embodiments in motor vehicles since the question of fitting the motor into the smallest possible space has a particularly great significance here.

In accordance with an embodiment, the electric motor concerned is a direct-current motor with brushes.

In accordance with a further embodiment, the flux propagation elements are embodied independently of the laminated core. In other words separate components are involved here which can be attached to the laminated core. Depending on the application, this means that differently-shaped and dimensioned flux propagation elements can be mounted on the laminated core. In addition this approach allows the number of the flux propagation elements used to be adapted in a simple manner to the requirements of the individual case.

For attachment of the flux propagation elements to the laminated core of the stator, in accordance with a further embodiment, the laminated core has a number of attachment contours. In other words the shape of the individual stator laminations is selected so that the said attachment contours are formed in the assembled state. The attachment contours in this case are advantageously embodied such that the flux propagation elements can be held therein without additional attachment means such as screws, clips etc., and that assembly of the flux propagation elements is possible without aids and additional adaptation, for example by simply plugging them in. Thus the various embodiments are above all suitable for low-cost direct-current motors. The flux propagation elements can be preferably fixed into the propagation contours with the aid of an adhesive. However they can also be held without an adhesive, for example by friction or a wedging effect in the attachment contours if these are formed into the appropriate shape.

In accordance with a further embodiment, the attachment contours are arranged around the circumference of the laminated core so that in the assembled state the flux propagation elements are arranged around the circumference of the stator. This increases the maximum effective surface of the flux propagation elements and thus makes for the best possible distribution of the flux in the stator.

In accordance with a further embodiment, the flux propagation elements have a plate shape. This makes the flux propagation elements especially easy to handle during assembly.

The various embodiments are especially suitable for motors with brushes with a commutator which increases the axial length of the motor on one side of the motor. In accordance with a further embodiment, the flux propagation elements thus project beyond the laminated core at least on the side on which the commutator is arranged, in order to make it possible to propagate the magnetic flux as well as possible in the axial direction.

In accordance with a further embodiment, the flux propagation elements project on both sides beyond the laminated core in order to make it possible to propagate the magnetic flux in the axial direction in the best possible manner. In this case the flux propagation elements preferably project beyond the laminated core on the side on which the commutator is arranged.

In accordance with a further embodiment, the rotor and the laminated core essentially have the same axial length. If both components are made of stamped metal sheets, manufacturing can in this case be undertaken especially effectively and with savings in materials. In addition this also provides advantages from the electrical or magnetic standpoint.

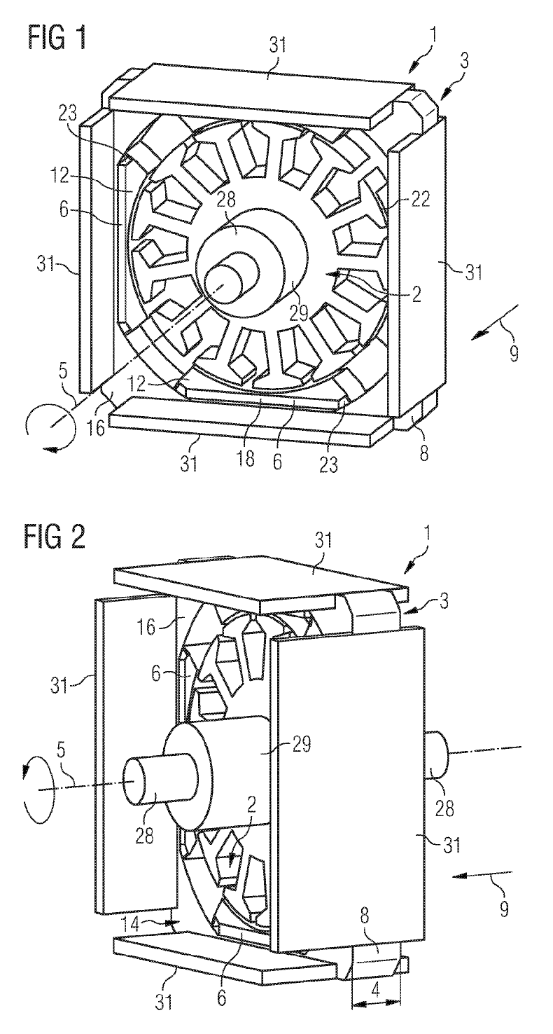

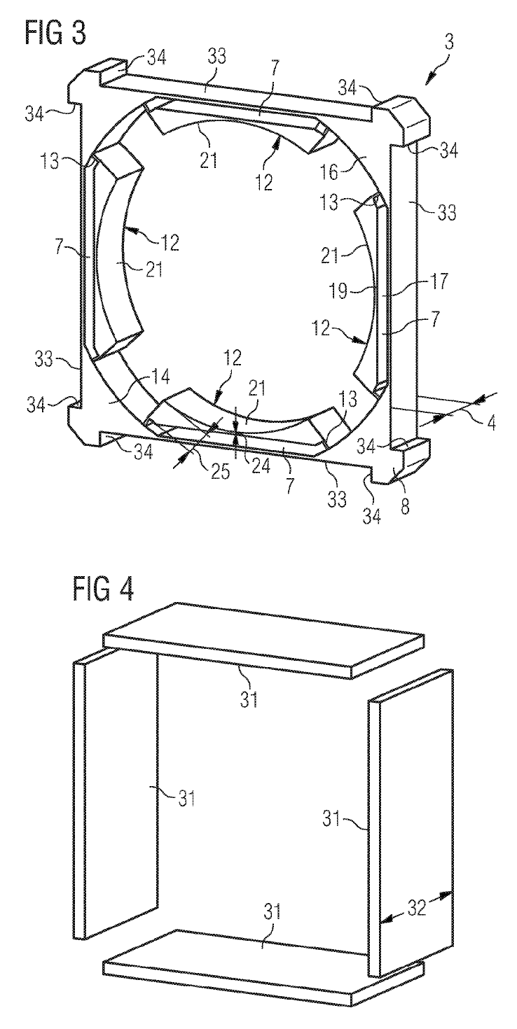

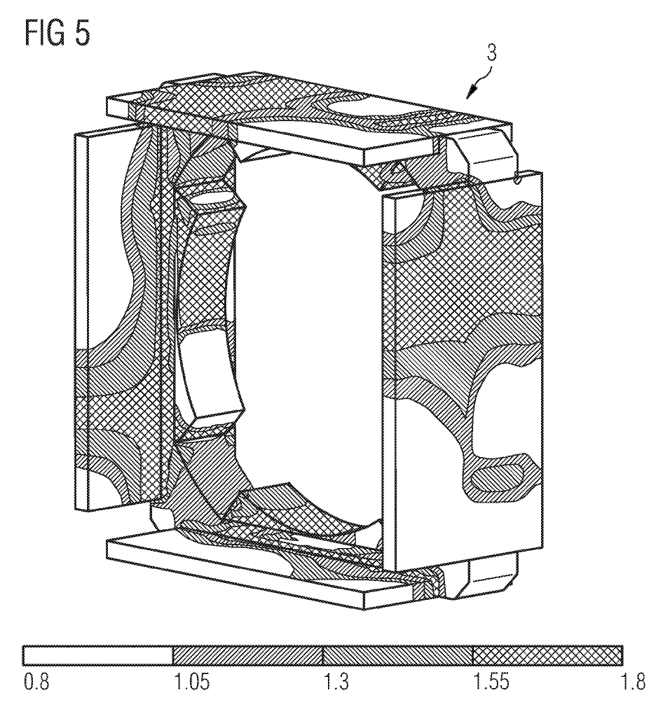

The direct-current motor according to an embodiment with brushes 1—as depicted in FIG. 1 to 4—has a rotor 2 and a stator 3. The rotor 2 rotates within the stator 3 on a shaft 28 around an axis of rotation 5. The shaft 28 is supported in a plastic stator housing not shown in the figure. The rotor 2 has a winding (not shown), which is supplied via brushes (both not shown) and a commutator 29 from a direct current source. The commutator 29 is arranged on the shaft 28.

The stator 3 essentially consists of a laminated core 8 with a plurality of stamped metal sheets (not shown individually), which are held together by the stator housing. Alternatively the stator sheets can also be held together by welding, clips, tie rods etc. which run in the channels of the laminated stator core. The laminated core 8 of the stator 3 has the same axial length 4 as the rotor 2. In this case the length 4 is small by comparison with the diameter of the direct current motor 1.

The shape of the individual stator plates is selected so that, in the assembled (laminated) state, the stator design described below is produced.

The stator 3 comprises four brick-shaped permanent magnets 6 which are embedded in pockets 7 of the stator 3 and form a 4-pole magnet arrangement. The four stator poles are in this case offset by 90° to each other. The permanent magnets 6 magnetized in the radial direction are rare earth magnets, for example based on NeFeB or SmCo. These exhibit improved magnetic characteristics by comparison with ferrite magnets.

Because of the higher remanence of the rare earth magnets greater magnetic field strengths can be achieved so that the motor can be dimensioned smaller overall. Rare earth magnets here are to be understood as magnets made of rare earth magnetic materials such as for example plastic-bound materials.

The axial length of the permanent magnets 6 corresponds to the axial length 4 of the stator 3. The permanent magnets 6 thus do not project beyond the laminated core 8 in the axial direction but are flush with the front or rear side of the laminated core 8.

The stator 3 has four pole shoes 12 which are connected in each case via two webs 13 to the yoke 16 and between which and the yoke 16 the pockets 7 for accommodating the permanent magnets 6 are formed. The thickness of the webs 13 is large enough for the mechanical rigidity of the construction to still be guaranteed. In this way the magnetic dispersion losses can be minimized. To obtain essentially brick-shaped pockets 7, the yoke 16 runs in a straight line in these sections of the stator 3.

The pockets 7 run in this case in the axial direction 9 from the one side 14 of the stator 3 to the opposite side of the stator 3 and lie symmetrical to the respective pole shoes 12. This means that the center 17 of the pocket, and thereby also the center 18 of the permanent magnet 6 held in the pocket 7, is assigned to the center 19 of the respective pole shoe 12. In this way a holder for the permanent magnet is formed in a constructively simple manner which at the same time makes possible a favorable movement of the magnetic flux.

The inner contour 21 of the pole shoe 12 pointing in the direction of the rotor 2 forms an air gap between the stator 3 and the rotor 2 which is as narrow as possible. The air gap 22 has an essentially constant width, in the present case around 1.3 mm. In other words the distance from the inner contour 21 of the pole shoe 12 to the rotor 2 is essentially constant. The radial thickness 24 of the pole shoe 12 is at its smallest in the center 17, 18, 19. Thus the distance of the brick-shaped permanent magnets 6 to the rotor 2 is minimal in this area. The radial thickness 24 of the pole shoes 12 in the center 17, 18, 19 is large enough here for the mechanical rigidity of the construction still to be guaranteed. The reduction of the radial thickness 24 of the pole shoes 12 in the central area means that there is a reduction in the magnetic stray flux which passes through the pole shoe 12 coming from the winding of the rotor 2.

The greater distance of the edges 23 of the brick-shaped permanent magnets 6 to the rotor 2 is compensated for by the shape of the pole shoes 12. The radial thickness 25 of the pole shoes 12 is in this area significantly greater than in the center area of the pole shoes 12, so that the distance to the rotor 2 is bridged with iron material. An undisturbed magnetic flux and thus a higher motor torque are thereby guaranteed. In this case the radial thickness and thereby the distance between the permanent magnets 6 and the rotor 2 changes continuously from the center area to the edge areas of the pole shoes 12.

The stator 3 comprises four plate-shaped massive flux propagation elements 31 made of steel, embodied independently of the laminated core 8, which serves jointly with the laminated core 8 to convey the magnetic flux. In this case the axial length 32 of the flux propagation elements 31 is greater than the axial length 4 of the laminated core 8.

The flux propagation elements 31 are embodied as separate components and attached to the laminated core 8. For this purpose the laminated core 8 has four attachment contours on its circumference in the form of mounting slots 33. The mounting slots 33 run in the axial direction 9 and are delimited to the side by retaining steps 34. In the assembly of the stator 3 the flux propagation elements 31 are laid in the mounting slots 33 and glued there with the aid of an adhesive. The flux propagation elements 31 then run in parallel to the permanent magnets 6 and there are thus, are also viewed radially, symmetric to the rotor 2. This produces an essentially rectangular form of the stator 2. The thickness of the plate-shaped flux propagation elements 31 is selected so that in the assembled state they are flush with the external contour of the laminated core 8.

The mounting slots 33 and the flux propagation elements 31 are dimensioned so that they extend over almost the entire length of the side of the stator 3. They thus form, in cross section, a square axial extension to the stator, of which the individual components, the flux propagation elements 31, do not move.

The flux propagation elements 31 extend in the axial direction 9 on both sides beyond the laminated core 8. In this case the flux propagation elements 31 project further beyond the laminated core 8 on the side on which the commutator 29 is arranged. The axial length 32 of the flux propagation elements 31 in this case does not however exceed the total length of the direct current motor 1.

With the flux propagation elements 31 according to various embodiments, the magnetic flux is propagated in the axial direction 9 over the entire width of the stator 3. FIG. 5 shows a typical result of a numerical simulation of a flux density distribution for this situation. The flux density is specified in Tesla here.

1. An electric motor with a stator which comprises a laminated core and a number of permanent magnets, and with a rotor interoperating with the stator and operable to be rotated around an axis of rotation, of flux propagation elements which serve jointly with the laminated core to convey the magnetic flux, and an axial length of stator is greater than an axial length of the laminated core.

2. The electric motor according to claim 1, wherein it is a direct-current motor with brushes.

3. The electric motor according to claim 1, wherein the flux propagation elements are embodied independently of the laminated core.

4. The electric motor according to claim 1, wherein the laminated core comprises a number of attachment contours for accommodating the flux propagation elements.

5. The electric motor according to claim 4, wherein the attachment contours are arranged around an outside of the laminated cores.

6. The electric motor according to claim 1, wherein the flux propagation elements have a plate shape.

7. The electric motor according to claim 1, wherein the flux propagation elements at least project beyond the laminated core on the side on which the commutator is arranged.

8. The electric motor according to claim 7, wherein the flux propagation elements project beyond the laminated core on both sides.

9. The electric motor according to claim 1, wherein the rotor and the laminated core have essentially the same axial length.

10. A method of providing an electric motor with a small diameter, the electric motor having a stator which comprises a laminated core and a number of permanent magnets, and with a rotor interoperating with the stator and operable to be rotated around an axis of rotation, the method comprising the step of:
providing the stator with a number of flux propagation elements which serve jointly with the laminated core to convey the magnetic flux wherein the axial length of which is greater than the axial length of the laminated core.

11. The method according to claim 10, wherein it is a direct-current motor with brushes.

12. The method according to claim 10, wherein the flux propagation elements are embodied independently of the laminated core.

13. The method according to claim 10, further comprising the step of providing a number of attachment contours to the laminated core for accommodating the flux propagation elements.

14. The method according to claim 13, further comprising the step of arranging the attachment contours around the outside of the laminated core.

15. The method according to claim 10, wherein the flux propagation elements have a plate shape.

16. The method according to claim 10, wherein the flux propagation elements at least project beyond the laminated core on the side on which the commutator is arranged.

17. The method according to claim 16, wherein the flux propagation elements project beyond the laminated core on both sides.

18. The method according to claim 10, wherein, the rotor and the laminated core have essentially the same axial length.

19. An electric motor comprising:
a stator with a laminated core comprising a number of flux propagation elements which serve jointly with the laminated core to convey the magnetic flux, wherein an axial length of the stator is greater than an axial length of the laminated core, and
a rotor interoperating with the stator and operable to be rotated around an axis of rotation, wherein the stator.

20. The electric motor according to claim 19, wherein the stator comprises a number of permanent magnets.
